(19) United States
(12) Patent Application Publication
(10) Pub. No.: US 2025/0368130 A1
(43) Pub. Date: Dec. 4, 2025

(54) METHOD FOR GENERATING ACOUSTIC DRIVING STATUS NOTIFICATION FOR AGRICULTURAL TRACTOR

(71) Applicant: Deere & Company, Moline, IL (US)

(72) Inventor: Lucas Schreieck, Mannheim (DE)

(21) Appl. No.: 19/218,758

(22) Filed: May 27, 2025

(30) Foreign Application Priority Data
Jun. 4, 2024 (EP) 24179737.2

(51) Int. Cl. B60Q 5/00

(52) U.S. Cl. CPC B60Q 5/005; B60Y 2200/221; B60Y 2302/03

(57) ABSTRACT

Method for generating an acoustic driving status notification for an agricultural tractor, in which a driving speed quantity which is characteristic for a current driving speed of the agricultural tractor is identified by a control unit and is compared with a preset maximum value in order to activate a transducer, arranged in a driver's station of the agricultural tractor, to generate acoustic driving speed information when it is detected that the preset maximum value has been exceeded.

This application claims priority to European Patent Application No. 24179737.2, filed Jun. 4, 2024, which is hereby incorporated by reference.

### TECHNICAL FIELD

The disclosure relates to a method for generating an acoustic driving status notification for an electrically powered agricultural tractor.

### BACKGROUND

The electrification of vehicle units previously operated by means of an internal combustion engine is playing an increasing role in agriculture too. In the case of agricultural tractors, depending on the intended use, this also concerns the propulsion unit. Whilst the operating sound of conventional internal combustion engines has allowed the driver to infer the current driving speed of the agricultural tractor without looking at a tachometer, this is usually not readily possible because of the very quiet running of electrical drives.

The very quiet running of such electric drives has resulted, inter alia, in noise-generating devices being compulsory in cars which imitate a driving noise that can be noticed by people outside when reversing and at driving speeds of up to 20 km/h. The generation of the noise is stopped at higher driving speeds because the rolling noise of the tires is then audible.

### SUMMARY

The object of the present disclosure is to adapt a method of the type mentioned at the beginning to the circumstances of an electrically powered agricultural tractor.

This object is achieved by a method for generating an acoustic driving status notification for an electrically powered agricultural tractor having the features of one or more embodiments disclosed herein.

The method for generating an acoustic driving status notification for an agricultural tractor provides that a driving speed quantity which is characteristic for a current driving speed of the agricultural tractor is identified by a control unit and is compared with a preset maximum value in order to activate a transducer, arranged in a driver's platform of the agricultural tractor, to generate acoustic driving speed information when it is detected that the preset maximum value has been exceeded.

This procedure takes into account the circumstances of agricultural tractors to the extent that, at relatively low driving speeds as are typical when carrying out tillage on arable land, feedback in terms of the driving speed here primarily takes place owing to the uneven ground acting via the tractor wheels. At higher driving speeds, as occur when driving on paved farm roads and public roads, these effects are considerably smaller and no longer allow the driver to receive a reliable indication for the actual driving speed of the agricultural tractor. The generation and output of the acoustic driving speed information can take place by a corresponding choice of the maximum value preset for the driving speed quantity in such a way that noticeability and estimation of the actual driving speed is significantly improved for the driver in the case of an agricultural tractor equipped with an electric drive. The maximum value of the driving speed is for this purpose typically preset in the region of 30 km/h.

The driver's platform can be open to the external environment and be protected only by a roll bar but it can also be a closed driver's cab. A loudspeaker installed in the region of a steering column or interior trim of the cab is used, for example, as the transducer which is electrically connected to a noise or acoustic synthesizer which can be activated by the control unit.

Advantageous developments of the method according to the disclosure are revealed in the one or more embodiments disclosed herein.

The intensity and/or sequence of the acoustic driving speed information generated is adapted by the control unit depending on the extent to which the preset maximum value is exceeded and hence as the driving speed continues to increase. This can be affected by raising the volume and/or increasing the frequency of a tone sequence generated by means of the transducer, in particular by corresponding modulation of a continuous tone or sound or by corresponding output of individual tones. For example, the output of an individual warning tone can also be provided.

It is additionally possible that the exception to the generation of the acoustic driving speed information is in the case of transportation of goods by road by the agricultural tractor, detected by the control unit. Because the agricultural tractor is operated on public roads at driving speeds of up to 60 km/h, correct estimation of the driving speed for the driver is here particularly valuable. This applies especially when the transportation of goods by road is performed with a (loaded) trailer attached to the agricultural tractor.

It can be inferred that transportation of goods by road is taking place by the control unit by evaluating cartographic information saved in a storage unit of a GPS navigation system. To do this, the control unit makes a comparison of the current geographic position determined by means of the GPS navigation system with the cartographic information saved in the storage unit in order to determine on the basis thereof whether the agricultural tractor is currently situated on a transport route formed by a paved farm road or a public road.

Other features and aspects will become apparent by consideration of the detailed description, claims, and accompanying drawings.

### BRIEF DESCRIPTION OF THE DRAWINGS

The detailed description of the drawings refers to the accompanying figures. The method according to the disclosure for generating an acoustic driving status notification for an electrically powered agricultural tractor is described in more detail hereinafter on the basis of the appended drawings.

FIG. 1 shows an exemplary embodiment, illustrated as a flow diagram, of the method according to the disclosure for generating an acoustic driving status notification for an electrically powered agricultural tractor.

FIG. 2 shows a schematically illustrated arrangement for performing the method according to the disclosure for generating an acoustic driving status notification for an electrically powered agricultural tractor.

Like reference numerals are used to indicate like elements throughout the several figures.

### DETAILED DESCRIPTION

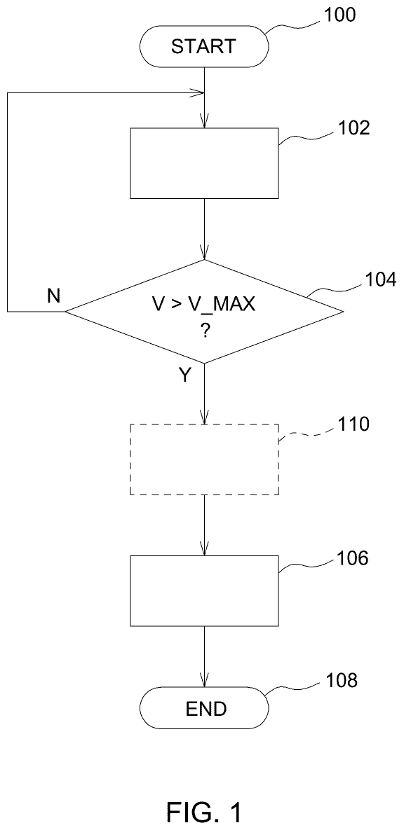

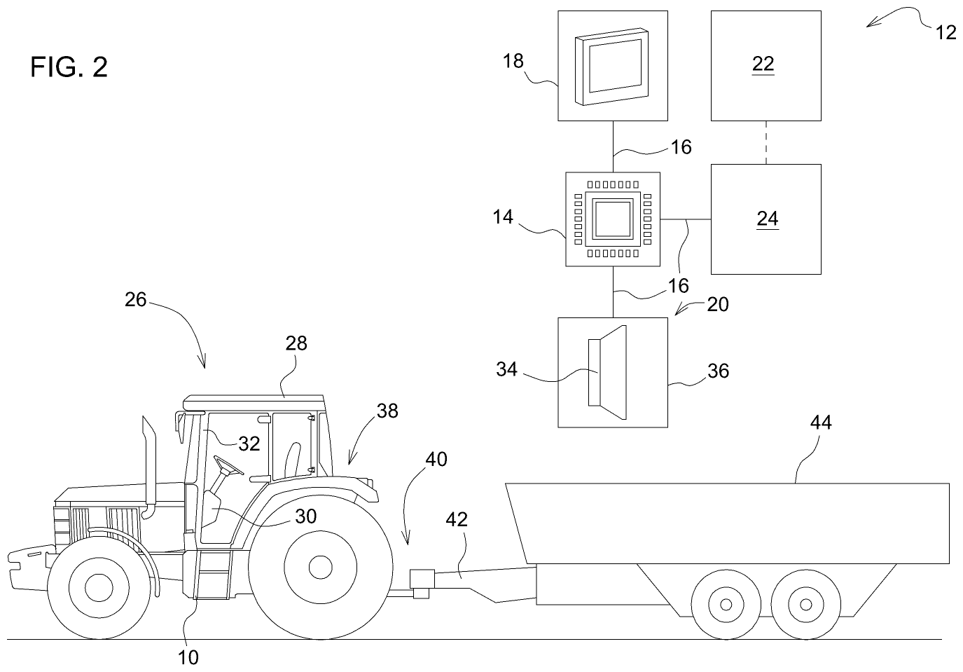

FIG. 1 shows an exemplary embodiment, illustrated as a flow diagram, of the method according to the disclosure for generating an acoustic driving status notification for an electrically powered agricultural tractor. This method will be described below with reference to the arrangement according to FIG. 2 provided for performing it.

The arrangement 12 accommodated in the agricultural tractor 10 comprises a microprocessor-controlled control unit 14 which communicates, via a CAN data bus 16, with a user interface 18, a transducer 20, and a GPS navigation system connected to a storage unit 22. The control unit 14 (controller) includes a processor and a memory.

The agricultural tractor 10 has, by way of example, a driver's platform 26 in the form of a closed driver's cab 28. A loudspeaker 34 installed in the region of a steering column 30 or interior trim 32 of the cab of the agricultural tractor 10 is used as the transducer 20 which is electrically connected to a noise or acoustic synthesizer 36 which can be activated by the control unit 14. Alternatively, the driver's platform 26 can also be open to the external environment and be protected by a roll bar.

A coupling device 40 (not visible in the chosen view) in the form of a coupling jaw to which a tow bar 42 of a pulled attachment or accessory 44 can be attached is furthermore situated in the rear region 38 of the agricultural tractor 10. The pulled attachment or accessory 44 is, for example, a trailer or loader wagon.

According to FIG. 1, the method performed by the control unit 14 is started in a start-up step 100 by the operator by calling up the corresponding assistance function via the user interface 18, after which, in a first main step 102, a driving speed quantity v which is characteristic for a current driving speed of the agricultural tractor 10 is identified by the control unit 14 on the basis of wheel speed information present at the CAN data bus 16.

The driving speed quantity v identified in the first main step 102 is then compared with a preset maximum value v_max by the control unit 14 in a second main step 104. If it is detected by the control unit 14 that the preset maximum value v_max has been exceeded, in a third main step 106 the transducer 20 arranged in the driver's platform 26 of the agricultural tractor 10 is activated in order to generate acoustic driving speed information. Otherwise, the method returns to the first main step 102 in order to be performed again. The maximum value v_max of the driving speed quantity v is preset in the region of 30 km/h.

The intensity and/or sequence of the acoustic driving speed information generated is here adapted in the third main step 106 by the control unit 14 depending on the extent to which the preset maximum value v_max is exceeded and hence as the driving speed continues to increase. This is affected by raising the volume and/or increasing the frequency of a tone sequence generated by means of the transducer 20, by corresponding modulation of a continuous tone or noise (for example, a synthetically generated engine noise) or by corresponding output of individual tones. In the simplest case, the output of an individual warning tone is provided.

Subsequently, the method is ended in a concluding step 108.

According to an optional embodiment of the disclosure, an intermediate step 110, in which an additional check is made as to whether the agricultural tractor 10 is being driven on a public road, and therefore transportation of goods by road is taking place, is added upstream from the third main step 106. The control unit 14 infers that transportation of goods by road is taking place by evaluating cartographic information saved in the storage unit 22 of the GPS navigation system 24. The control unit 14 makes a comparison of the current geographic position determined by means of the GPS navigation system 24 with the cartographic information saved in the storage unit 22 in order to determine on the basis thereof whether the agricultural tractor 10 is currently situated on a transport route formed by a paved farm road or a public road.

In other words, the exception to the generation of the acoustic driving speed information is in this embodiment in the case of transportation of goods by road by the agricultural tractor 10, detected by the control unit 14.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A method for generating an acoustic driving status notification for an agricultural tractor, comprising:
identifying, by a control unit, a driving speed quantity which is characteristic for a current driving speed of the agricultural tractor; and
comparing, by the control unit, the driving speed quantity with a preset maximum value in order to activate a transducer, arranged in a driver's platform of the agricultural tractor, to generate acoustic driving speed information when it is detected that the preset maximum value has been exceeded.

2. The method of claim 1, comprising adapting, by the control unit, the intensity or sequence of the acoustic driving speed information generated depending on the extent to which the preset maximum value is exceeded.

3. The method of claim 1, wherein the exception to the generation of the acoustic driving speed information is in the case of transportation of goods by road by the agricultural tractor, detected by the control unit.

4. The method of claim 3, wherein the transportation of goods by road is taking place is inferred by the control unit by evaluating cartographic information saved in a storage unit of a GPS navigation system.

5. A system for generating an acoustic driving status notification for an agricultural tractor, comprising:
a transducer arranged in a driver's platform of the agricultural tractor; and
a control unit configured to identify a driving speed quantity which is characteristic for a current driving speed of the agricultural tractor and to compare the driving speed quantity with a preset maximum value in order to activate the transducer to generate acoustic driving speed information when it is detected that the preset maximum value has been exceeded.

6. The system of claim 5, wherein the intensity or sequence of the acoustic driving speed information generated is adapted by the control unit depending on the extent to which the preset maximum value is exceeded.

7. The system of claim 5, wherein the exception to the generation of the acoustic driving speed information is in the case of transportation of goods by road by the agricultural tractor, detected by the control unit.

8. The system of claim 5, wherein the transportation of goods by road is taking place is inferred by the control unit by evaluating cartographic information saved in a storage unit of a GPS navigation system.
